(19) United States
(12) Patent Application Publication
(10) Pub. No.: US 2023/0266694 A1
(43) Pub. Date: Aug. 24, 2023

(54) DEVELOPING DEVICE AND IMAGE FORMING APPARATUS INCLUDING THE SAME

(71) Applicant: KYOCERA Document Solutions Inc., Osaka (JP)

(72) Inventor: Nobuhiro MAEZAWA, Osaka-shi (JP)

(73) Assignee: KYOCERA Document Solutions Inc., Osaka (JP)

(21) Appl. No.: 18/005,173

(22) PCT Filed: Jul. 12, 2021
(86) PCT No.: PCT/JP2021/026152

§ 371 Date: Jan. 11, 2023

(30) Foreign Application Priority Data
Jul. 17, 2020 (JP) 2020-123084

(51) Int. Cl. G03G 15/08; G03G 21/00; G03G 15/20

(52) U.S. Cl. CPC G03G 15/0808; G03G 21/0088; G03G 15/2028; G03G 2215/066; G03G 2215/025

(57) ABSTRACT

A developing device (33) includes a developing roller (331) disposed so as to face a photosensitive drum (31), a supply roller (332) and a layer thickness regulating member (334). The supply roller (332) supplies the toner to the developing roller (331) while collecting the toner from the developing roller (331). The layer thickness regulating member (334) has a fixed end portion (334T), a base side straight portion (A), a tip side straight portion (B), a first arc portion (C) and a second arc portion (D). The radius of curvature of the second arc portion (D) is set to be smaller than that of the first arc portion (C).

### TECHNICAL FIELD

The present invention relates to a developing device which develops an electrostatic latent image formed on a photosensitive drum using a non-magnetic one-component developer and to an image forming apparatus including the developing device.

### BACKGROUND

Conventionally, as a developing device developing an electrostatic latent image formed on a photosensitive drum using a nonmagnetic one-component developer used in an image forming apparatus such as a printer, a developing device described in Patent Document 1 is known. Such a developing device includes a developing housing, a developing roller, a supply roller which supplies toner to the developing roller, and a toner regulating blade (a layer thickness regulating member) which regulates the layer thickness of the toner on the developing roller. The toner regulating blade is disposed so as to extend downstream in the rotational direction of the developing roller, and has an edge portion coming into contact with the developing roller. The edge portion of the toner regulating blade is formed by a plurality of curved surfaces whose radius of curvature decreases toward the upstream side in the rotational direction of the developing roller, and the downstream curved surface of the curved surfaces comes into contact with the developing roller. Therefore, it becomes possible to reduce an amount of conveyed toner while a wide contact width between the toner regulating blade and the developing roller is ensured. As a result, the elastic deformation at the tip of the edge portion is reduced and wear is reduced, so that a desired toner layer can be formed and a stable amount of toner charge can be obtained.

In addition, in the developing device disclosed in Patent Document 2, the tip portion of the developer amount control blade (the layer thickness regulating member) is bent over the entire width toward the opposite side to the developer carrier (the developing roller), so that the quality variation in shape of the tip portion of the blade is suppressed and the amount of toner on the developer carrier is kept more uniform.

### PRIOR ART DOCUMENTS

### Patent Literature

Patent Document 1: Japanese Patent Laid-Open No. 2001-305856
Patent Document 2: Japanese Patent Laid-Open No. 2007-293106

### SUMMARY OF THE INVENTION

### Problems to be Solved by Invention

In the technique described in Patent Document 1, since the layer thickness regulating member is disposed so as to extend downstream in the rotational direction of the developing roller, a large amount of toner can easily enter the regulating nip formed by the layer thickness regulating member coming into contact with the developing roller at one time, and the toner can easily aggregate in the regulating nip. As a result, the toner layer on the developing roller is partially thin corresponding to the position of the toner agglomerates on the developing roller, and therefore, when an image with a high image density (a solid image) is printed, stripes are likely to occur on the image. In addition, in the technique described in Patent Document 2, since the bending of the layer thickness regulating member increases its rigidity, the line pressure is increased and the width of the regulating nip area is thus widened. Therefore, since the layer thickness regulating member comes into contact with the developing roller with a strong pressing force, the amount of toner on the developing roller after the layer thickness regulating tends to decrease, and the amount of toner enough to be consumed from the developing roller to the photosensitive drum during continuous printing of a solid image cannot be supplied from the layer thickness regulating member to the developing nip area. As a result, image defects such as density drop and density unevenness due to poor followability may easily occur.

The present invention is made to solve the above problems and to provide a developing device which can reduce an image density difference between the leading edge portion and the trailing edge portion of a sheet in a solid image by stabilizing a supply performance of toner to a developing roller while reducing a stress applied to the toner when the toner passes through a regulating nip area and an image forming apparatus including the developing device.

### Means of Solving the Problems

A sheet conveyance apparatus according to one aspect of the present invention includes: a developing housing in which a nonmagnetic one-component toner is stored; a developing roller formed of a cylindrical elastic body, rotatably supported by the developing housing, disposed so as to face a predetermined photosensitive drum at a developing nip, and carrying the toner on its circumferential surface; a supply roller formed of a cylindrical foamed elastic body, rotatably supported by the developing housing, coming into contact with the circumferential surface of the developing roller to form a supply nip between the developing roller and the supply roller, and supplying the toner to the developing roller while collecting the toner from the developing roller; and a layer thickness regulating member coming into contact with the circumferential surface of the developing roller on a downstream side of the supply nip in a rotational direction of the developing roller, and regulating a thickness of the toner on the developing roller, wherein when the layer thickness regulating member is viewed from an axial direction of the developing roller in a state where the layer thickness regulating member is not in contact with the developing roller, the layer thickness regulating member has a shape containing: a fixed end portion fixed to the developing housing; a base side straight portion extending linearly from the fixed end portion toward the circumferential surface of the developing roller on an upstream side in the rotational direction of the developing roller; a tip side straight portion forming a free end of the layer thickness regulating member on an opposite side to the fixed end portion and extending linearly in a direction away from the circumferential surface of the developing roller; and a plurality of circular arc portions which are continuous with each other so as to connect the base side straight portion and the tip side straight portion, and are configured to have a radius of curvature smaller as closer to the tip side straight portion.

An image forming apparatus according to one aspect of the present invention includes the developing device; and a photosensitive drum on which an electrostatic latent image is formed on the surface and to which the toner is supplied from the developing roller.

### Effects of the Invention

According to the present invention, the developing device in which an image density difference between the leading edge portion and the trailing edge portion of a sheet in a solid image can be reduced by stabilizing a supply performance of toner to a developing roller while reducing a stress applied to the toner when the toner passes through a regulating nip area, and an image forming device including the same are provided.

### BRIEF DESCRIPTION OF DRAWINGS

FIG. 1 is a sectional view showing an internal structure of an image forming apparatus according to one embodiment of the present invention.

FIG. 2 is a sectional view showing a photosensitive drum and its periphery of the image forming apparatus according to the embodiment of the present invention.

FIG. 3 is an enlarged sectional view showing a supply nip area between a developing roller and a supply roller of a developing device according to the embodiment of the present invention.

FIG. 4 is a schematic sectional view showing a layer thickness regulating member of the developing device according to the embodiment of the present invention.

FIG. 5 is a schematic sectional view showing a state where the layer thickness regulating member of the developing device according to the embodiment of the present invention is in contact with the developing roller.

FIG. 6 is a schematic sectional view showing a layer thickness regulating member of another developing device compared with the developing device according to the embodiment of the present invention.

FIG. 7 is a schematic sectional view showing a state where the layer thickness regulating member of another developing device compared with the developing device according to the embodiment of the present invention is in contact with the developing roller.

### EMBODIMENT FOR CARRYING OUT THE INVENTION

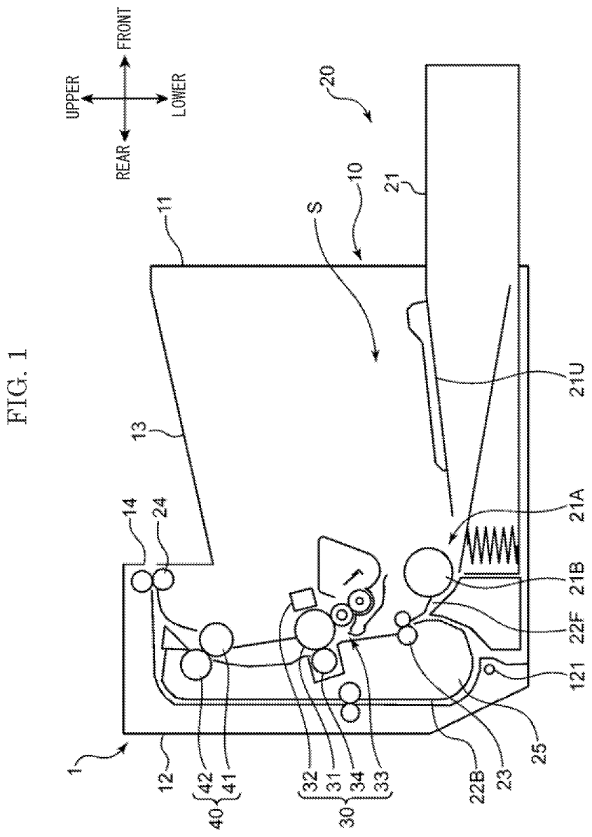

Hereinafter, based on the drawings, an embodiment of the present invention will be described in detail. FIG. 1 is a side sectional view showing an internal structure of an image forming apparatus 1 according to one embodiment of the present invention. Here, a monochrome printer is shown as an example of the image forming apparatus 1, but the image forming apparatus may be a copying machine, a facsimile machine, or a multifunctional peripheral having these functions, or an image forming apparatus that forms a color image.

The image forming apparatus 1 includes a main body housing 10 having an approximately rectangular box-shaped housing structure, and a sheet feeding part 20, an image forming part 30 and a fixing part 40 housed in the main body housing 10.

A front cover 11 is provided on the front side of the main body housing 10, and a rear cover 12 is provided on the rear side. The rear cover 12 is a cover which is opened during sheet jam or maintenance. On the upper surface of the main body housing 10, a sheet discharging part 13 from which the sheet after image forming is discharged is provided. In the internal space S defined by the front cover 11, the rear cover 12 and the sheet discharging part 13, various devices for performing the image forming are stored.

The sheet feeding part 20 includes a sheet feeding cassette 21 in which a sheet to be subjected to the image forming processing is housed. A part of the sheet feeding cassette 21 projects further forward from the front surface of the main body housing 10. The upper surface of the sheet feeding cassette 21 housed in the main body housing 10 is covered by the sheet feeding cassette top plate 21U. The sheet feeding cassette 21 includes a sheet storage space for storing a bundle of the sheets, a lift plate for lifting up the bundle of sheets for sheet feeding, and the others. A sheet sending part 21A is provided above the rear end portion of the sheet feeding cassette 21. In this sheet sending part 21A, a sheet feeding roller 21B which feeds the uppermost sheet of the bundle of sheets in the sheet feeding cassette 21 one by one is disposed.

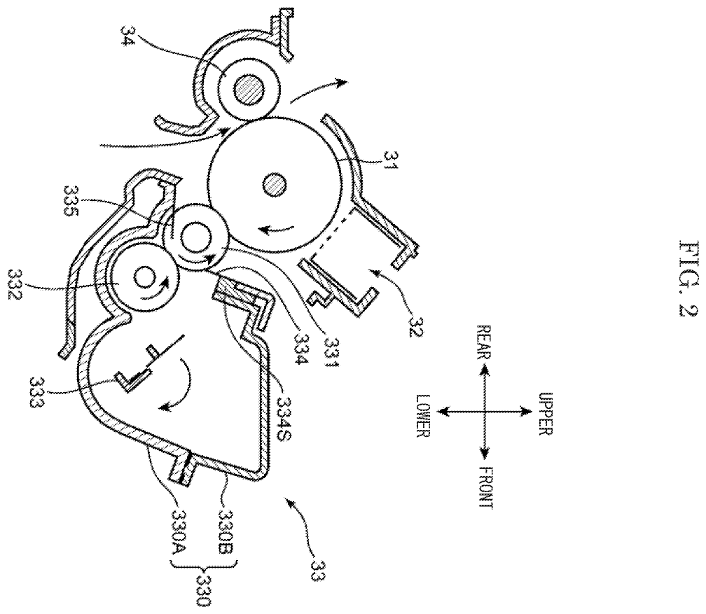

An image forming part 30 performs the image forming processing to form a toner image on the sheet fed from the sheet feeding part 20. The image forming part 30 includes a photosensitive drum 31, and a charging device 32, an exposure device (not shown in FIG. 2), a developing device 33 and a transfer roller 34 which are disposed around the photosensitive drum 31.

The photosensitive drum 31 includes a rotating shaft and a cylindrical surface rotating around the rotating shaft. An electrostatic latent image is formed on the cylindrical surface, and a toner image corresponding to the electrostatic latent image is carried on the cylindrical surface. As the photosensitive drum 31, an OPC photoreceptor drum may be used.

The charging device 32 uniformly charges the surface of the photosensitive drum 31, and includes a scorotron which is disposed away from the photosensitive drum 31 at a predetermined distance and discharges when a predetermined voltage is applied.

The exposure device includes a laser light source and an optical element such as a mirror and a lens, and forms the electrostatic latent image by irradiating the circumferential surface of the photosensitive drum 31 with light modulated based on image data given from an external device such as a personal computer.

The developing device 33 supplies a toner to the circumferential surface of the photosensitive drum 31 in order to develop the electrostatic latent image on the photosensitive drum 31 and to form the toner image.

The transfer roller 34 is a roller for transferring the toner image formed on the circumferential surface of the photosensitive drum 31 onto the sheet. The transfer roller 34 comes into contact with the cylindrical surface of the photosensitive drum 31 to form a transfer nip. The transfer roller 34 is applied with a transfer bias of opposite polarity to that of the toner.

The fixing part 40 performs fixing processing for fixing the transferred toner image on the sheet. The fixing part 40 includes a fixing roller 41 with a heating source inside and a pressure roller 42 which comes into pressure-contact with the fixing roller 41 to forms a fixing nip between the fixing roller 41 and the pressure roller 42. When the sheet on which the toner image is transferred is passed through the fixing nip, the toner image is heated by the fixing roller 41 and pressed by the pressure roller 42 to be fixed on the sheet. In this embodiment, the melt viscosity (Pas) of the nonmagnetic one-component toner used in the developing device 33 at 95 degrees is set in the range of 10,000 to 200,000.

In the main body housing 10, a main conveyance path 22F and an inversion conveyance path 22B are provided to convey the sheet. The main conveyance path 22F extends from the sheet sending part 21A of the sheet feeding part 20 through the image forming part 30 and the fixing part 40 to a sheet discharge port 14 provided facing the sheet discharging part 13 on the upper surface of the main body housing 10. The inversion conveyance path 22B is a conveyance path for returning the single-sided printed sheet to the upstream side of the image forming part 30 in the main conveyance path 22F when double-sided printing is performed on the sheet.

The main conveyance path 22F is extended to pass through the transfer nip formed by the photosensitive drum 31 and the transfer roller 34 from the lower side to the upper side. In addition, a registration rollers pair 23 is disposed upstream of the transfer nip on the main conveyance path 22F. The sheet is temporarily stopped at the registration rollers pair 23, and after skew correction is performed, is sent to the transfer nip at a predetermined timing for image transfer. On suitable positions of the main conveyance path 22F and the inversion conveyance path 22B, a plurality of conveyance rollers for conveying the sheet are disposed, and for example, a discharge rollers pair 24 is disposed near the discharge port 14.

The inversion conveyance path 22B is formed between the outer surface of an inversion unit 25 and the inner surface of the rear cover 12 of the main body housing 10. One of the transfer rollers 34 and the registration rollers pair 23 is mounted on the inner surface of the inversion unit 25. The rear cover 12 and the inversion unit 25 are turnable around a fulcrum 121 provided at their lower end portions. When a sheet jam occurs in the inversion conveyance path 22B, the rear cover 12 is opened. When a sheet jam occurs in the main conveyance path 22F or when the unit of the photosensitive drum 31 or the developing device 33 is detached outside, the inversion unit 25 is also opened in addition to the rear cover 12.

FIG. 2 is a sectional view showing the structure around the photosensitive drum 31 and its peripheral. In this embodiment, the transfer roller 34 is disposed so as to come into contact with the photosensitive drum 31 behind the photosensitive drum 31, and the charging device 32 is disposed so as to face the photosensitive drum 31 at a predetermined interval in front and above the photosensitive drum 31. The transfer nip is formed between the photosensitive drum 31 and the transfer roller 34, and the sheet passes through the transfer nip as shown by the arrow in FIG. 2. At this time, the toner image is transferred from the photosensitive drum 31 to the sheet.

The developing device 33 is disposed so as to face the photosensitive drum 31 in front and below the photosensitive drum 31. The developing device 33 includes a developing housing 330, a developing roller 331, a supply roller 332, an agitating paddle 333, a regulating blade 334 (a layer thickness regulating member) and a lower seal 335 (a sealing member).

The developing housing 330 houses the non-magnetic one-component toner inside. The developing housing 330 has a housing body 330A and a housing lid 330B. As shown in FIG. 2, an opening is formed in the rear end portion of the developing housing 330 for exposing a part of the developing roller 331 to the photosensitive drum 31.

The developing roller 331 is rotatably supported by the developing housing 330, and has a circumferential surface on which the toner is carried. The developing roller 331 is in contact with the photosensitive drum 31, and forms a developing nip for supplying the toner to the photosensitive drum 31, together with the photosensitive drum 31. In the developing roller 331, a cylindrical rubber layer (an elastic body) is formed around a shaft of SUS or SUM material. The rubber layer is made of NBR (Nitril-Butadiene Rubber) rubber as an example. A predetermined coat layer may be formed on the surface of the rubber layer. In this embodiment, the hardness of the surface of the developing roller 331 is set in the range of the Asker-C hardness of 50 to 80.

The supply roller 332 is disposed so as to face the developing roller 331 in front and below the developing roller 331, and is rotatably supported by the developing housing 330. The supply roller 332 comes into contact with the developing roller 331 to form a supply nip for supplying the toner to the developing roller 331. The supply roller 332 is formed by fixing a cylindrical urethane sponge or foamed sponge (both the elastic foamed body) around a predetermined metal shaft (the shaft member). In this embodiment, the surface hardness of the supply roller 332 is set in the range of Asker-FP hardness from 40 to 60. The supply nip width, when viewed along the radial direction, is set in a range of 0.2 mm to 1.5 mm in the rotational direction.

The agitating paddle 333 is rotatably supported by the developing housing 330 in front of the supply roller 332. The agitating paddle 333 includes an L-shaped shaft in cross section as shown in FIG. 2, and a PET film disposed to extend radially from the shaft.

In addition, FIG. 2 shows the direction of rotation of the developing roller 331, the supply roller 332 and the agitating paddle 333 when the image forming processing is performed on the sheet in the image forming apparatus 1. The developing roller 331 is rotated so that its circumferential surface moves in the same direction as the circumferential surface of the photosensitive drum 31 at the developing nip. As an example, the circumferential speed ratio of the developing roller 331 to the photosensitive drum 31 is set at 1.55. The supply roller 332 is rotated so that its circumferential surface moves in the opposite direction to the rotational direction of the circumferential surface of the developing roller 331. The circumferential speed ratio of the developing roller 331 to the supply roller 332 is set at 1.55. The agitating paddle 333 rotates so as to feed the supply roller 332 while scooping up the toner in the developing housing 330.

The regulating blade 334 comes into contact with the surface (the circumferential surface) of the developing roller 331 on the downstream side of the supply nip in the rotational direction of the developing roller 331 and on the upstream side of the developing nip in the rotational direction of the developing roller 331. The regulating blade 334 is fixed to the developing housing 330 so as to incline toward the upstream side in the rotational direction of the developing roller 331. The regulating blade 334 regulates the thickness (the layer thickness) of the toner on the developing roller 331.

The lower seal 335 is supported by the housing body 330A so as to close the gap between the developing roller 331 and the housing body 330A on the opposite side to the regulating blade 334. The tip portion of the lower seal 335 comes into contact with the surface of the developing roller 331.

In this embodiment, as shown in FIG. 2, when viewed from the transfer nip formed by the photosensitive drum 31 and the transfer roller 34, the charging device 32 is disposed on the downstream side in the rotational direction of the photosensitive drum 31, and a so-called cleanerless configuration is adopted in which a known cleaning device is not provided. That is, when the toner image is transferred from the photosensitive drum 31 to the sheet at the transfer nip, the non-transferred toner remains on the photosensitive drum 31. The non-transferred toner passes through the charging device 32 and is recovered from the photosensitive drum 31 by the developing roller 331 of the developing device 33. In this case, if an image (the toner image) is continuously formed on the sheet, the developing roller 331 collects the non-transferred toner from the photosensitive drum 31, while supplying the toner to the electrostatic latent image on the photosensitive drum 31.

On the other hand, the supply roller 332 supplies new toner to the developing roller 331 at the supply nip, while collecting the toner not supplied from the developing roller 331 to the photosensitive drum 31 from the developing roller 331.

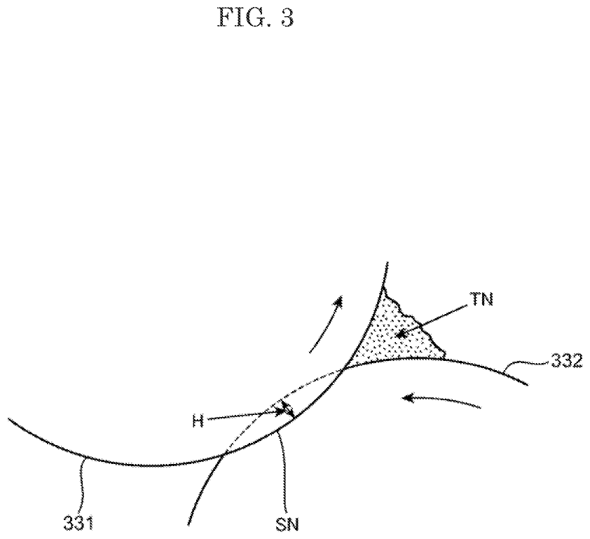

FIG. 3 is an enlarged sectional view showing the developing roller 331 and the supply roller 332 which face each other, in the developing device 33 according to one embodiment of the present invention. In this embodiment, the shafts of the developing roller 331 and the supply roller 332 are supported by the developing housing 330 such that the surface of the developing roller 331 bites the surface of the supply roller 332 by an amount H. As a result, between the developing roller 331 and the supply roller 332, the supply nip SN having a predetermined width along their rotational direction is formed. Since the hardness of the supply roller 332 is lower than that of the developing roller 331, the supply nip SN is formed mainly by the deformation of the surface of the supply roller 332, as shown in FIG. 3. Therefore, when the developing roller 331 and the supply roller 332 are rotated, the toner carried by the supply roller 332 stays at the upstream side of the supply nip SN, and a toner pool TN is formed. Due to the toner pool TN, the toner can be stably supplied from the supply roller 332 to the developing roller 331 even when a high density image is formed on the photosensitive drum 31.

On the other hand, when the developing roller 331 and the supply roller 332 may point-contact each other in a sectional view, the toner pool TN as shown in FIG. 3 is not sufficiently formed, so that the toner suppling ability may be significantly reduced.

For this reason, it is desirable that the distance between the axes (the distance between the shafts) of the developing roller 331 and the supply roller 332 and their diameters are set so as to obtain a suitable amount of bite H. The hardness of the developing roller 331 is set in a range of Asker-C hardness from 50 to 80 because the developing roller 331 comes into contact with a hard member such as the photosensitive drum 31. Therefore, it is desirable that the hardness of the supply roller 332 is set lower than that of the developing roller 331 in order to have a configuration in which the developing roller 331 bites the supply roller 332 as shown in FIG. 3.

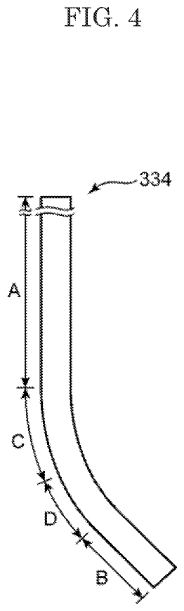

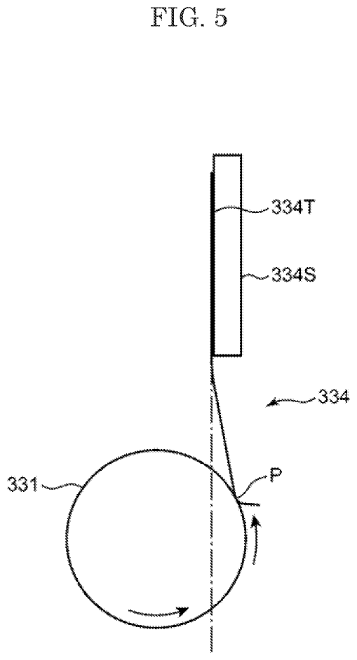

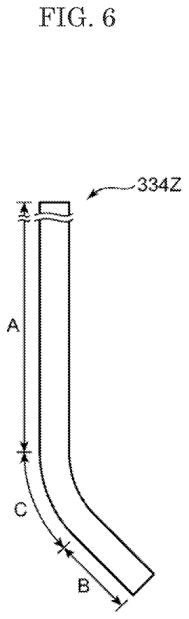

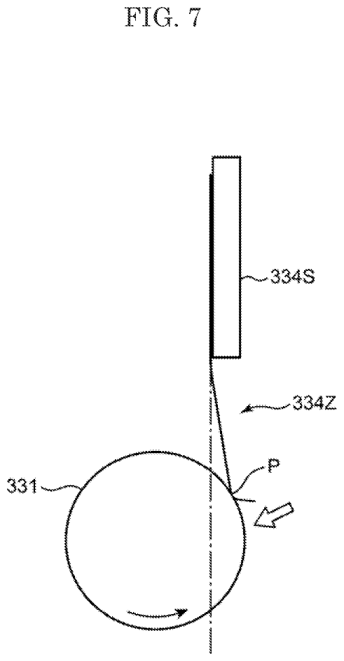

FIG. 4 is a schematic sectional view showing the regulating blade 334 of the developing device 33 according to this embodiment. FIG. 5 is a schematic sectional view showing a state in which the regulating blade 334 of the developing device 33 according to this embodiment comes into contact with the developing roller 331. On the other hand, FIG. 6 is a schematic sectional view showing the regulating blade 334Z of another developing device compared with the developing device 33 according to this embodiment. FIG. 7 is a schematic sectional view showing a state in which the regulating blade 334Z of another developing device compared with the developing device 33 according to this embodiment is in contact with the developing roller 331.

With reference to FIG. 4, in the present embodiment, when the regulating blade 334 is viewed from the axial direction of the developing roller 331 in a state where the regulating blade 334 is not in contact with the developing roller 331, the regulating blade 334 has a fixed end portion 334T (FIG. 5), a base side straight portion A, a tip side straight portion B, a first arc portion C, and a second arc portion D.

The fixed end portion 334T is the portion of the regulating blade 334 that is fixed to the developing housing 330, and is supported by a support member 334S fixed to the developing housing 330. In FIG. 2, the support member 334S is formed of multiple members, but the support member 334S may be a single member.

The base side straight portion A is a portion of the regulating blade 334 that extends linearly from the fixed end portion 3341 toward the circumferential surface of the developing roller 331 upstream in the rotational direction of the developing roller 331.

The tip side straight portion B is a portion of the regulating blade 334 that forms a free end portion of the regulating blade 334 on the opposite side to the fixed end portion 3341 and extends linearly away from the circumferential surface of the developing roller 331.

The first arc portion C and the second arc portion D are a plurality of arc portions that are continuous with each other so as to connect the base side straight portion A and the tip side straight portion B. The radius of curvature of the circular arcs are set to be smaller as they are closer to the tip side straight portion B. That is, the radius of curvature of the second arc portion D in FIG. 4 is smaller than the radius of curvature of the first arc portion C.

When the regulating blade 334 is supported by the support member 334S, as shown in FIG. 5, the first arc portion C and the second arc portion D of the regulating blade 334 come into contact with the circumferential surface of the developing roller 331 to form the regulating nip P. The toner supplied from the supply roller 332 to the developing roller 331 is regulated at the regulating nip P and then supplied to the developing nip where the photosensitive drum 31 and the developing roller 331 face each other.

According to the above configuration, the radius of curvature of the arc portions (the first arc portion C, the second arc portion D) of the regulating blade 334 is set to be smaller as they are closer to the tip side straight portion B. In other words, the radius of curvature of the arc portions are set larger toward the downstream side in the rotational direction of the developing roller 331. Therefore, around the regulating nip P, the toner layer can be gradually regulated by each arc shape while the arc portions surface-press the toner layer toward the circumferential surface of the developing roller 331. As a result, the toner easily enters the regulating nip P smoothly. At this time, since the base side straight portion A of the regulating blade 334 extends linearly from the fixed end portion 334T toward the circumferential surface of the developing roller 331 on the upstream side in the rotational direction of the developing roller 331, the entering of a large amount of the toner into the regulating nip P at one time is suppressed compared with the case where the regulating blade 334 is disposed so as to extend toward the downstream side in the rotational direction of the developing roller 331, and the aggregation of the toner in the regulating nip P is suppressed. In the above configuration, among the arc portions, the arc portion having a small radius of curvature is disposed on the upstream side, so that while the toner smoothly enters the regulating nip P as described above, the excessive toner tends to flow away from the circumferential surface of the developing roller 331 along the shape of the arc portions on the upstream side and the tip side straight portion B, and a large amount of the toner is prevented from remaining on the upstream side of the regulating nip P. With such a dynamic toner flow, the toner supplied from the supply roller 332 to the developing roller 331 easily passes through the regulating nip P, and the toner can be stably and continuously supplied to the developing nip from the leading edge portion to the trailing edge portion of the sheet having a solid image. As a result, the image density difference between the leading edge portion and the trailing edge portion of the sheet having the solid image can be reduced by stabilizing the supply performance of the toner to the developing roller 331 while reducing the stress that the toner is applied when the toner passes through the regulating nip P.

Furthermore, in the present embodiment, when the regulating blade 334 is viewed from the axial direction of the developing roller 331 in a state where the regulating blade 334 does not come into contact with the developing roller 331, the arc portions (the first arc portion C, the second arc portion D) form a clothoid curve. That is, the inclinations of the tangents of the first arc portion C and the inclination of the tangent of the second arc portion D are continuously set so as to include the boundary portion between the first arc portion C and the second arc portion D. The same applies to the boundary portion between the first arc portion C and the base side straight portion A, and the boundary portion between the second arc portion D and the tip side straight portion B.

According to the configuration, since the arc portions are connected in such a way that the inclinations of their tangents continuously change, unstable flow of the toner at the boundary portions between the adjacent arc portions is suppressed, and the stress of the toner around the regulating nip P is further reduced.

In a state where the developing device 33 is assembled, that is, the regulating blade 334 is in contact with the developing roller 331, the support member 334S supports the fixed end portion 334T of the regulating blade 334 so that a part of the first arc portion C and a part of the second arc portion D of the regulating blade 334 are in contact with the circumferential surface of the developing roller 331. That is, in this embodiment, the area including the boundary portion between the first arc portion C and the second arc portion D comes into contact with the circumferential surface of the developing roller 331 with a predetermined width.

According to the configuration, in the regulating nip P, since the arc portions can stably surface-press the toner layer toward the circumferential surface of the developing roller 331, the toner layer can be gradually regulated by each arc shape more stably. As a result, it becomes easy for the toner to enter the regulating nip P more smoothly.

The regulating blade 334 according to the present embodiment is made of SUS 301-CSP specified in JIS G4313 to which one of ¾·H, H and EH tempering treatments is subjected or SUS 304-CSP specified in JIS G4313 to which one of ¾·H and H tempering treatments is subjected.

According to this configuration, by using a stainless steel spring material to which a prescribed tempering treatment is subjected, as the regulating blade 334, it is possible to increase the hardness of the regulating blade 334 while maintaining a spring performance. As a result, the layer thickness regulating function for the toner can be stably maintained over a long period of time.

Furthermore, it is further desirable that the melt viscosity (Pa·s) of the non-magnetic one-component toner used in the developing device 33 at 95 degrees be set in the range of 10,000 to 200,000. In this case, it becomes possible to reduce the power input to the fixing part 40 in order to fix the toner to the sheet. On the other hand, even if the toner has such a relatively low melt viscosity and the viscosity tends to increase depending on the temperature in the device, the regulating blade 334 having the shape as described above can stabilize the supplying performance of the toner to the developing roller 331 while reducing the stress applied to the toner when passing through the regulating nip P. This makes it possible to reduce image defects such as density drop and density unevenness when the solid images are printed continuously.

In the image forming apparatus 1 having the developing device 33 as described above, the image density difference between the leading edge portion and the trailing edge portion of the sheet having the solid image can be reduced by stabilizing the supplying performance of the toner to the developing roller while reducing the stress applied to the toner when passing through the regulating nip by using the non-magnetic toner.

### Examples

Next, a preferred mode of the developing device 33 will be described based on an example. Each experiment was performed under the following experimental conditions.

### <Experimental Conditions>

Photosensitive drum 31: OPC drum,
Number of rotation of photosensitive drum 31: 118 rpm,
Number of rotations of developing roller 331: 267 rpm,
Circumferential speed ratio of developing roller 331 to photosensitive drum 31: 1.55,
Development bias DC component: 300 V,
Supply bias DC component: 400 V,
Surface potential of photosensitive drum 31: 650 V,
Diameter of developing roller 331: 13 mm,
Asker-C hardness of the developing roller: 70,
Diameter of supply roller 332: 13 mm,
Diameter of photosensitive drum 31: 24 mm,
Average particle size of non-magnetic toner: 8.0 μm (D 50),
Regulating blade 334,

Material: SUS 304 CSP 1H, thickness 0.1 mm,

Blade free length: 8.4 mm,

Tip radius of curvature: 0.3 mm,

Tip length: 0.3 mm, Bite amount: 0.9 mm, and

Pressing load: 45 N/m.

Table 1 shows the detailed conditions and experimental results for each present example and comparative example. In the comparative example, a solid image was printed using the regulating blade 334Z shown in FIG. 6 and FIG. 7, and in the example, a solid image was printed using the regulating blade 334 according to the present embodiment shown in FIG. 4 and FIG. 5. In both cases, the concentration at the leading end portion and the trailing end portion of the sheet and the concentration difference between the concentrations were measured.

TABLE 1

| | Comparative | |
|---|---|---|
| Blade | Example | Example |
| Concentration at leading end portion | 1.43 | 1.444 |
| Concentration at trailing end portion | 1.192 | 1.305 |
| Difference in concentration | 0.238 | 0.139 |

As shown in Table 1, in comparison with the comparative example, in the example, the decrease in image density at the trailing end portion of the sheet is suppressed, and stable density can be maintained over the entire surface. It is presumed that this result is due to the fact that although there is no difference in the conveying amount of the toner between the example and the comparative example at the leading end portion of the solid image where the toner is sufficiently supplied, a difference in the amount of the toner passing through the regulating nip P occurs at the trailing end portion of the sheet where the supply amount of the toner is reduced. It is estimated that the remaining of the toner on the upstream side of the regulating nip P is high in the comparative example, while the remaining described above is low in the example.

The same evaluation result (effect) as above was reproduced in the range below where the diameter of the developing roller 331 was between 11.0 mm and 15.0 mm. Similarly, the same evaluation result (effect) as above was reproduced in the range of the circumferential speed ratio between the developing roller 331 and the supply roller 332 (the circumferential speed of the developing roller 331 is higher) from 1.3 to 1.8.

The developing device 33 and the image forming apparatus 1 having the developing device 33 are described above. According to the present invention, the developing device 33 capable of reducing the image density difference between the leading end portion and the trailing end portion of the sheet having a solid image by stabilizing the supplying performance of the toner to the developing roller while reducing the stress applied to the toner when passing through the regulating nip, and the image forming device including the developing device can be provided. The present invention is not limited to this, and for example, the following modified embodiment can be adopted.

(1) In the above embodiment, the image forming apparatus 1 is provided with one developing device 33, but the image forming apparatus 1 may be a color image forming apparatus including the developing device 33 corresponding to each of a plurality of colors.

(2) In the above embodiment, the developing housing 330 of the developing device 33 stores a nonmagnetic toner inside, but it may have a toner container and a toner cartridge that store the nonmagnetic toner separately from the developing housing 330.

(3) In the above embodiment, the regulating blade 334 has the two arc portions (the first arc portion C, the second arc portion D), but the present invention is not limited to this. The regulating blade 334 may have three or more arc portions, and these arc portions may preferably form a clothoid curve.

1. A developing device comprising:
a developing housing in which a nonmagnetic one-component toner is stored;
a developing roller formed of a cylindrical elastic body, rotatably supported by the developing housing, disposed so as to face a predetermined photosensitive drum at a developing nip, and carrying the toner on its circumferential surface;
a supply roller formed of a cylindrical foamed elastic body, rotatably supported by the developing housing, coming into contact with the circumferential surface of the developing roller to form a supply nip between the developing roller and the supply roller, and supplying the toner to the developing roller while collecting the toner from the developing roller; and
a layer thickness regulating member coming into contact with the circumferential surface of the developing roller on a downstream side of the supply nip in a rotational direction of the developing roller, and regulating a thickness of the toner on the developing roller, wherein
when the layer thickness regulating member is viewed from an axial direction of the developing roller in a state where the layer thickness regulating member is not in contact with the developing roller,
the layer thickness regulating member has a shape containing:
a fixed end portion fixed to the developing housing;
a base side straight portion extending linearly from the fixed end portion toward the circumferential surface of the developing roller on an upstream side in the rotational direction of the developing roller;
a tip side straight portion forming a free end of the layer thickness regulating member on an opposite side to the fixed end portion and extending linearly in a direction away from the circumferential surface of the developing roller; and
a plurality of circular arc portions which are continuous with each other so as to connect the base side straight portion and the tip side straight portion, and are configured to have a radius of curvature smaller as closer to the tip side straight portion.

2. The developing device according to claim 1, further comprising:
a support member which supports the fixed end portion of the layer thickness regulating member such that at least two of the arc portions come into contact with the circumferential surface of the developing roller.

3. The developing device according to claim 2, wherein
the layer thickness regulating member contains two of the arc portions.

4. The developing device according to claim 1, wherein
a pressing load of the layer thickness regulating member on the developing roller is 40 to 50 N/m.

5. The developing device according to claim 1, wherein
when the layer thickness regulating member is viewed from an axial direction of the developing roller in the state where the layer thickness regulating member is not in contact with the developing roller, the arc portions form a clothoid curve.

6. The developing device according to claim 1, wherein
the layer thickness regulating member is made of SUS301-CSP specified in JIS G4313 subjected to one of ¾H, H and EH tempering treatments or SUS304-CSP specified in JIS G4313 subjected to one of ¾ H and H tempering treatments.

7. The developing device according to claim 1, wherein
a melt viscosity (Pa·s) of the toner at 95 degrees is set in the range of 10,000 to 200,000.

8. An image forming apparatus comprising:
the developing device according to claim 1; and
a photosensitive drum on which an electrostatic latent image is formed on the surface and to which the toner is supplied from the developing roller.
